(19) United States
(12) Patent Application Publication
(10) Pub. No.: US 2024/0010959 A1
(43) Pub. Date: Jan. 11, 2024

(54) A PROCESS FOR THE PRODUCTION OF BEER

(71) Applicant: ANADOLU EFES BiRACILIK VE MALT SAN. A. S., Ümraniye/Istanbul (TR)

(72) Inventors: Serkan Akin, Ümraniye/Istanbul (TR); Koray Anar, Ümraniye/Istanbul (TR)

(21) Appl. No.: 18/011,334

(22) PCT Filed: Jun. 16, 2021
(86) PCT No.: PCT/TR2021/050613

§ 371 Date: Dec. 19, 2022

(30) Foreign Application Priority Data
Jun. 25, 2020 (TR) 2020/10012

(51) Int. Cl. C12C 7/04; C12C 11/00; C12C 12/04

(52) U.S. Cl. CPC C12C 7/04; C12C 11/00; C12C 12/04

(57) ABSTRACT

A process for the production of beer. More particularly, the invention relates to a step of mashing for the beer production process. In particularly, the present invention relates firstly to the mashing of a first portion of the milled malt to be fed to a mashing step and then, to the mashing the same again with a second portion. In said mashing process, the ratio of the first portion of the milled malt to the total milled malt is at most 50% by weight. In another aspect, the invention relates to the use of mashing method according to the invention for the production of beer. In a further aspect, the invention relates to beer obtained by the mashing method.

### TECHNICAL FIELD OF THE INVENTION

The present invention relates to a process for the production of beer. More particularly, the invention relates to a step of mashing for the beer production process. In particularly, the present invention relates to the mashing of a first portion of the milled malt to be fed to a mashing step and then, to the mashing the same again together with a second portion. In said mashing process, the ratio of the first portion of the milled malt to the total milled malt is at most 50% by weight.

In another aspect, the invention relates to the use of mashing method according to the invention for the production of beer. In a further aspect, the invention relates to beer obtained using the mashing method according to the invention.

### BACKGROUND OF THE INVENTION

Beer is a low-alcohol drink comprising carbon dioxide, which is obtained by an alcoholic fermentation of the malt wort aromatized with hops. Briefly, a process for the production of beer comprises the steps of milling, mashing, lautering, boiling, cooling, yeast and air dosing, fermentation, maturation, filtration, and filling. The malt obtained by germinating and kilning barley is mashed with water under certain conditions, and beer is obtained, which comprises alcohol and CO₂ that are obtained as a result of the alcoholic fermentation of the wort after boiling with hops. The malt is obtained by steeping, germinating and kilning the barley. Subsequently, the resulting malt is milled and transferred to a mashing process.

Mashing is a process in which the nutritional elements with simple molecules (maltose and low molecular weight sugars from starch and peptides and amino acids from a protein structure), which are fermentable by the yeast in the fermentation step are prepared. The mashing process is carried out in tuns fitted with specialized agitator and heating systems using temperature and time programs. The mashing process may be classified into two types depending on the way of raising the temperature: infusion mashing and decoction mashing.

During infusion mashing, the mash tun is heated gradually in order for the enzymes β-amylase and α-amylase to reach their optimum temperatures. This yields efficient results in the well-processed malts. Decoction mashing is a process in which a portion of the mash is taken from the tun immediately and returned to the mash tun after it is boiled in the tun to which it is transferred. A much more energy is caused to be consumed as compared to the known methods.

In the state of the art, there is a need for the methods which does not have the drawbacks of these methods used for the production of beer, but also allow beers which is easy to drink and has a high degree of fermentation to be obtained.

One way to increase the degree of fermentation in particular is to use commercial enzymes. Higher degrees of fermentation may be achieved easily due to the commercial enzymes. However, only water, malt, hops and yeast should be used in the production of beer according to the German purity law which is a guide for the production processes. In this context, the biochemical additives such as commercial enzymes are not suitable for use. In order for the resulting beer to have the desired characteristics, the quality of the raw material used in the method of production is important, and production parameters which is difficult to be managed should be used, such as longer mashing times.

During mashing process, first β-amylase (62° C.) and then, a-amylase (70° C.) among the enzymes which are naturally found in the barley malt sequentially work according to their optimum working temperatures. The enzyme a-amylase randomly breaks down the long starch chains into smaller structures. In other words, it creates new ends to be degraded by β-amylase.

The fact that firstly, the enzyme α-amylase works at an optimum working temperature (70° C.) and then, the β-amylase actively works at a lower temperature (62° C.) means reversing this situation offered us by nature, which offers a disadvantage in terms of brewery.

Although the use of a commercial enzyme may allow that disadvantageous situation to be overcome easily, products which are against the German Purity Law are obtained.

In this context, an object of the present invention is to obtain beer in accordance with the German purity law. Also, the present invention aims at offering a mashing method in which no commercial enzyme is used. Another object of the invention is to offer a method of obtaining beer in accordance with the German purity law with minimal variation in the production process.

### BRIEF DESCRIPTION OF THE FIGURES

FIG. 1 is a flow chart showing a mashing method according to the invention.

FIG. 2 is a temperature-time diagram showing an embodiment of a mashing method according to the invention.

### DETAILED DESCRIPTION OF THE INVENTION

In particularly, the present invention relates firstly to the mashing of a first portion of the milled malt to be fed to a mashing step and then, to the mashing the same again with a second portion. In said mashing process, the ratio of the first portion of the milled malt to the total milled malt is at most 50% by weight.

Accordingly, the invention relates to a mashing method in the production of beer, and said method comprises the steps of:
a. mashing of a first portion of the milled malt in a separate tun,
b. combining the first portion of the malt which completes the first mashing cycle with the other second portion of malt, subjecting that combination to a second mashing cycle and mashing them together;
   wherein the first portion of the malt is at most 50% by weight of the total milled malt.

In a preferred embodiment of the invention, the ratio of the first portion of the malt to the total milled malt is 20% to 45% by weight.

In another aspect, the mashing method used in the method for the production of beer according to the invention comprises the following steps.
a. Heating (101) a first portion of the milled malt to a temperature in the range of 60 to 65° C.,
b. Maturating (102) the first portion at a temperature in the range of 60 to 65° C. for t₁ time for the first enzyme activation,
c. After resting, raising (103) the temperature of the first portion to a temperature of 70 to 75° C.,
d. Resting (104) the temperature of the first portion at a temperature in the range of 70 to 75° C. for t₂ time for the second enzyme activation,
e. Combining the first portion, the first mashing cycle of which is completed, with the other second portion of the malt and repeating (105) the steps b. to d.

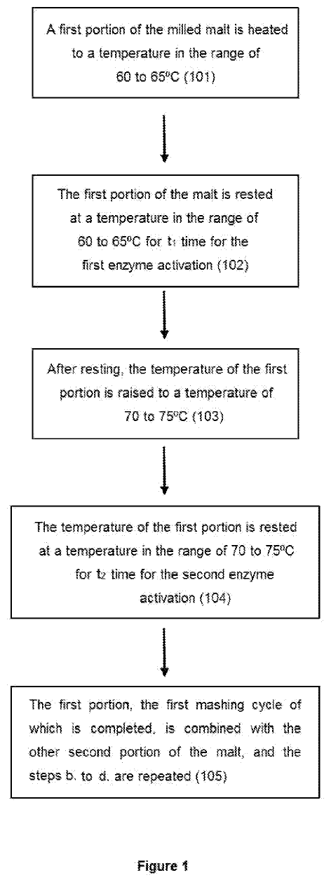

An embodiment of the method according to the invention is shown in a flow diagram of FIG. 1.

In a preferred embodiment of the invention, the temperature in step b. of the mashing method is from 62 to 64° C.

In an embodiment of the invention, the temperature in step c. of the mashing method is from 70 to 72° C.

In further embodiment of the invention, the ti time in step b. of the mashing method is from 20 to 60 minutes, preferably from 35 to 45 minutes.

In another embodiment of the invention, the t 2 time in step d. of the mashing method is from 15 to 45 minutes, preferably from 20 to 30 minutes.

In another embodiment of the invention, the mashing method of the invention comprises an optional additional resting step (106) between the first enzyme activation (step b.) and the second enzyme activation (step d.) during the second mashing cycle.

In this preferred embodiment of the invention, the additional resting step lasts from 1 to 30 minutes.

In a particularly preferred embodiment of the invention, the additional resting step lasts from 5 to 15 minutes.

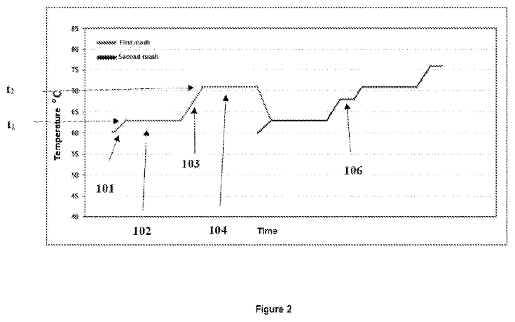

The mashing method of the invention is representatively shown in a temperature-time diagram of FIG. 2.

The t₁ time and t₂ time and the temperatures in the steps b. and c. in the mashing method of the invention vary depending on the optimum working temperatures of the first and second enzymes and the quality of the raw material. Said values are calculated according to the data of pasting analysis of Barley Malt which is also the raw material used. This analytic data may vary depending on the climatic conditions in the year during which the product is harvested.

The first enzyme and the second enzyme which work in the mashing method of the invention are β-amylase and α-amylase, respectively. Thus, in the mashing process of the invention, the temperature is raised such that first β-amylase and then, α-amylase will work during both mashing cycle. However, the first mash is rested again in the second mash tun at a temperature of 62-64° C. after the end of the first mashing cycle (70-72° C.) is combined with the beginning of the second mashing cycle (at a temperature below 62° C.) due to the double mashing. With this method, the enzyme β-amylase is subjected to an optimum working temperature after the enzyme α-amylase which has worked during the mashing cycle therefor.

In the mashing process of the invention, tanks with heaters and agitators are used.

The optional additional resting step (106) is an intermediate temperature resting which is optionally used according to the characteristics of the raw material used.

The resting steps are the periods of time, during which the temperature remains constant, and the time vary depending on the qualities of the raw material.

Said qualities of the raw material may be the analytical values such as viscosity, kolbach index, friability, which are indicative of the modification level in the process of conversion from barley to malt according to the analyzes showing the enzyme content and activity of the barley malt (diastatic power, amylase activity).

In another aspect, the invention relates to the use of the mashing method of the invention for the production of beer.

In a further aspect, the invention relates to beer which is obtained using the mashing method of the invention and contains no commercial enzyme.

In the fermentation step of the mashing method of the invention, the brewer's yeast has been observed to increase the ratio of the nutritional elements which may be fermented thereby in the total to 65% when it is 60% by weight, and to 70% when it is 65%.

In another aspect, accordingly, the invention relates to beer obtained using the mashing method of the invention, in which the ratio of the nutritional elements which may be fermented by a brewer's yeast is from 60% to 70% in the total during the fermentation step and the nutritional elements are converted into alcohol by a fermentation process.

In the fermentation step, the nutritional elements which may be fermented by the brewer's yeast may be low molecular weight sugars such as maltose, maltotriose, sucrose, glucose and fructose, which are obtained from starch.

The mashing method of the invention is also called “double mashing”, and in the double mashing process, a portion of the milled malt is taken into a separate mash tun for the mashing process and mashed first at a resting temperature of β-amylase and then at a resting temperature of a-amylase. That mash for which the α-amylase is active is transferred to the mash tun which is prepared with the remaining portion of the malt.

Thus, the degradable sugar molecules formed by the a-amylase enzyme in the first mash tank for the β-amylase are cleaved into simple sugars by the β-amylase by a remashing process in the second mash tun. Thereby, the first mash is rested 1 more time in every step.

By a double mashing process, more nutritional elements which are fermentable by the yeast are formed. Furthermore, the double mashing process allows beer according to the German purity law to be obtained as no commercial enzyme is used.

By the mashing method of the invention, beers which are easy to drink and have a high degree of fermentation are produced according to the sensoric assessments carried out by the trained beer degustators and taste tests of consumers.

1. A mashing method for the production of beer, characterized in that said method comprises the steps of:
a. mashing of a first portion of the milled malt in a separate tun,
b. combining the first portion of the malt which completes the first mashing cycle with the other second portion of malt, subjecting that combination to a second mashing cycle and mashing them together;
wherein the first portion of the malt is at most 50% by weight of the total milled malt.

2. The mashing method according to claim 1, characterized in that the ratio of the first portion of the malt to the total milled malt is 20% to 45% by weight.

3. The mashing method according to any one of claim 1, characterized in that said method comprises the following steps.
a. Heating (101) the first portion of the milled malt to a temperature in the range of 60 to 65° C.,
b. Resting (102) the first portion at a temperature in the range of 60 to 65° C. for t₁ time for the first enzyme activation,
c. After resting, raising (103) the temperature of the first portion to a temperature of 70 to 75° C.,
d. Resting (104) the temperature of the first portion at a temperature in the range of 70 to 75° C. for t2 time for the second enzyme activation,
e. Combining the first portion, the first mashing cycle of which is completed, with the other second portion of the malt, and repeating (105) the steps b. to d.

4. The mashing method according to claim 3, characterized in that the temperature in step b. is from 62 to 64° C.

5. The mashing method according to claim 3, characterized in that the temperature in step c. is from 70 to 72° C.

6. The mashing method according to claim 3, characterized in that the h time in step b. is from 20 to 60 minutes.

7. The mashing method according to claim 6, characterized in that the h time in step b. is from 35 to 45 minutes.

8. The mashing method according to claim 3, characterized in that the t2 time in step d. is from 15 to 45 minutes.

9. The mashing method according to claim 8, characterized in that the t2 time in step d. is from 20 to 30 minutes.

10. A mashing method according to claim 3, characterized in that it comprises an optional additional resting step (106) between the first enzyme activation (step b.) and the second enzyme activation (step d.) during the second mashing cycle.

11. A mashing method according to claim 10, characterized in that the additional resting step is from 1 to 30 minutes.

12. A mashing method according to claim 11, characterized in that the additional resting step is from 5 to 15 minutes.

13. Use of a mashing method according to claim 1 for the production of beer.

14. A beer characterized in that it is obtained using a mashing method according to claim 1 and has no commercial enzyme.

15. A beer characterized in that it is obtained by a mashing method according to claim 1, wherein the ratio of the nutritional elements fermentable by a brewer's yeast during the fermentation step in the total is from 60% to 70%, and the beer is obtained by fermenting the nutritional elements and converting them into alcohol.
